(19) United States
(12) Patent Application Publication
(10) Pub. No.: US 2015/0242061 A1
(43) Pub. Date: Aug. 27, 2015

(54) AUTOMATIC BOOKMARK OF A SELECT LOCATION WITHIN A PAGE OF AN EBOOK RESPONSIVE TO A USER TOUCH GESTURE

(71) Applicant: KOBO Incorporated, Toronto (CA)

(72) Inventors: Sneha PATEL, Toronto (CA); Anthony O'DONOGHUE, Toronto (CA)

(73) Assignee: KOBO Incorporated, Toronto (CA)

(21) Appl. No.: 14/188,456

(22) Filed: Feb. 24, 2014

(51) Int. Cl. G06F 3/0481; G06F 3/0484; G06F 3/0488; G06F 3/01

(52) U.S. Cl. CPC G06F 3/0481; G06F 3/017; G06F 3/04842; G06F 3/0488

(57) ABSTRACT

System and method for bookmark a select location with a page of an ebook. A graphical user interface (GUI) is configured to display content of a page, and bookmark a select location within the page responsive to a swipe gesture starting from a predetermined position on the GUI. The end position of swipe gesture is recorded as the bookmark and a visual object representing the bookmark is rendered on the GUI. The select location may correspond to a last line that a user just finished reading before closing the reading session of the electronic document. The visual object may be removed from the electronic document once a user can locate the select location in a subsequent reading session.

### TECHNICAL FIELD

The present disclosure relates generally to the field of electronic books, and, more specifically, to the field of graphical user interfaces for electronic books.

### BACKGROUND

The use of electronic devices to read books, newspapers and magazines in electronic forms has become increasingly commonplace due to the numerous significant advantages afforded by such devices over conventional paper print. For example, comparing to paper print, an electronic reading device can hold greater amounts of information, allow immediate access to new books, personalize the reading display format, and facilitate night reading, etc. Electronic reading devices can be implemented as dedicated reading devices, e.g., e-readers, as well as general-purpose electronic devices, such as desktop, laptop and hand-held computers.

A user reading a document often needs to bookmark or label selected terms, lines, paragraphs or pages, e.g., for purposes of highlighting, outlining, annotation, referencing, convenient revisit, etc. Various application programs rendering electronic content on electronic reading devices can allow a user to make on-screen bookmarks on selected book locations in a variety of forms. For example, through a book reading graphical user interface (GUI), selected content can be highlighted, underlined, annotated, linked to a comment balloon, or displayed in a different color.

A bookmark made for a whole page can facilitate a user to later locate the particular page. FIG. 1 illustrates a user interaction with a book reading GUI 101 to bookmark a book page on an electronic reading device in accordance with the prior art. In this instance, when a user 102 taps a specific location 104 on the GUI 101, the current page is bookmarked and an on-screen mark 103 (e.g., a dog-ear mark) is visually rendered at a corner of the page.

Generally, when a user closes an ebook before finishing it, the reading experience program can record the location of the last page, e.g., by the page number, that the user just finished. When the ebook is subsequently reopened in the new reading session, the last page can be presented directly in the GUI. However, unless a user manually creates a bookmark on the last line where he or she just finished reading, it is difficult for the user to locate the last page line quickly in the new reading session even if the last page is located. As a result, the user often has to repeat reading a significant portion of the page that he or she already read before the last line is reached and recognized.

Alternatively, by using a conventional labeling function provided by the reading program, a user can bookmark the line where he or she just finished or wants to start in the next reading session. However, such a bookmark remains visible in the ebook until the user specifically removes it. In reality, the bookmark likely becomes obsolete once the user locates the last-read line at the beginning of a new reading session. According to the conventional approach, removing a bookmark typically involves a series of user input, as selecting the bookmark and then changing it to the ordinary display format. In addition, since these labeling functions (e.g., underlining, highlighting, margin annotating) are not specifically designed to bookmark the last-read line, a bookmark made for the last-read line has the same visual appearance as many other bookmarks made for other purposes. Thus, a user may find this practice confusing and distracting.

### SUMMARY OF THE INVENTION

Therefore, it would be advantageous to provide a mechanism to facilitate a reader-user of an electronic document to bookmark a select portion of a select page.

Embodiments of the present disclosure employ a computer implemented method of rendering a graphical user interface (GUI) configured to generate a bookmark on a select portion of a displayed page upon detecting a user swipe (or slide, or drag) gesture input originating from a predetermined location on the GUI. The end location of the swipe gesture is recorded as a bookmark of the electronic document. The bookmark visual object may be rendered in a form of a bar starting from the predetermined location and directing to the select portion. The select portion may correspond to a last line that the user just finished reading in a reading session. The bookmark object is visible in a subsequent reading session of the electronic document for a predetermined time, and then disappears automatically or in response to a user command. Advantageously, the location of a select portion can be quickly identified by the bookmark at the beginning of a reading session.

According to one embodiment of the present disclosure, a computer implemented method of bookmarking a location in an electronic book comprises: (1) accessing content of the electronic book; (2) rendering an on-screen GUI on a touch sensitive display device in a first view session to display a portion of the electronic book; (3) detecting an indication of a slide gesture via the touch sensitive display device, wherein the indication comprises data representing a start location of the slide gesture and data representing an end location of the slide gesture, wherein the start location corresponds to a predetermined location with reference to the on-screen GUI; (4) recording the end location with reference to the portion as a bookmark for the electronic book; and (5) rendering an on-screen indicia on the on-screen GUI, the on-screen indicia indicating the end location with reference to the portion.

The GUI may comprise an on-screen graphical object indicating the predetermined location, and wherein the portion is a page. The on-screen graphical object may remain invisible until a user interaction with the touch sensitive display device is detected proximate to the predetermined location. The on-screen indicia may comprise a bar object connecting the predetermined location and the end location. Rendering the on-screen indicia may further comprise displaying a part of the page that precedes the end location in a text display format different from a part of the page following the end location.

The method may further comprise: (1) ending the first view session of the electronic book in response to a first user request via the on-screen GUI, wherein the ending is performed subsequent to the recording; (2) rendering the on-screen GUI on the touch sensitive display device to display the portion in response to a second user request to start a second view session of the electronic book, wherein the second user request is received through the touch sensitive display device subsequent to the ending; and (3) displaying the on-screen indicia on the on-screen GUI in the second view session.

In another embodiment of the present disclosure, a non-transitory computer-readable storage medium embodying instructions that, when executed by a processing device, cause the processing device to perform a method of labeling a location in an electronic document. The method comprises: (1) rendering a GUI for reading on a touchscreen display; (2) displaying a portion of the electronic document on the GUI in a first reading session of the electronic document; (3) receiving an indication of a swipe gesture via the touchscreen display, wherein the indication comprises data representing a start position of the swipe gesture with reference to the GUI, and data representing an end position of the swipe gesture with reference to the portion of the electronic document, wherein the start position coincides with a predetermined position on the GUI; (4) storing the end position with reference to the electronic document as a bookmark; and (5) closing the first reading session in response to a user request; (6) responsive to a user request to start a second reading session subsequent to the closing, displaying the portion of the electronic document on the GUI; and (7) rendering an on-screen indicia on the GUI in the second reading session, wherein the on-screen indicia is indicative of the end position.

In another embodiment of the present disclosure, a system comprises: a touch sensitive display device operable to detect user gestures; a processor coupled to the touch sensitive display device; and memory coupled to the processor and comprising instructions that, when executed by the processor, cause the system to perform a method of bookmarking a location in an electronic book. The method comprises: (1) accessing content of the electronic book; (2) rendering an on-screen graphical user interface (GUI) on the touch sensitive display device in a first view session to display a page of the electronic book; (3) receiving an indication of a slide gesture via the touch sensitive display device, wherein the indication comprises data representing a start location of the slide gesture and data representing an end location of the slide gesture, wherein the start location corresponds to a predetermined location with reference to the on-screen GUI; (4) recording the end location with reference to the page as a bookmark; and (5) rendering an on-screen indicia on the on-screen GUI, the on-screen indicia indicating the end location with reference to the page.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates a user interaction with a book reading GUI to bookmark a book page on an electronic reading device in accordance with the prior art.

FIG. 2 is a flow chart depicting an exemplary computer implemented method of bookmarking a select location within a page of an electronic book responsive to a user swipe gesture input in accordance with an embodiment of the present disclosure.

FIG. 3 illustrates an exemplary GUI configured to receive a user swipe gesture via a touchscreen display to bookmark a text line in an electronic document in accordance with an embodiment of the present disclosure.

FIG. 4 is a block diagram illustrating an exemplary computing system including a reading experience program capable of bookmarking a select location within a select page of a document responsive to a user gesture input in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the Mowing detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer systems registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

Automatic Bookmark of a Select Location within a Page of an Ebook Responsive to a User Touch Gesture

Overall, embodiments of the present disclosure employ a computer implemented method of presenting a graphical user interface (GUI) configured to display the content of a page of an electronic document, and automatically bookmark a select location within the page responsive to a user swipe (or drag or slide) gesture starting from a predetermined position on the GUI. The end position of the swipe gesture is recorded as the bookmark and a visual object representing the bookmark is rendered on the GUI. In some embodiments, the select location may correspond to a last line that the reader just finished reading before closing the reading session of the electronic document. The visual object may be automatically removed from the electronic document once a user can locate the select location in a subsequent reading session.

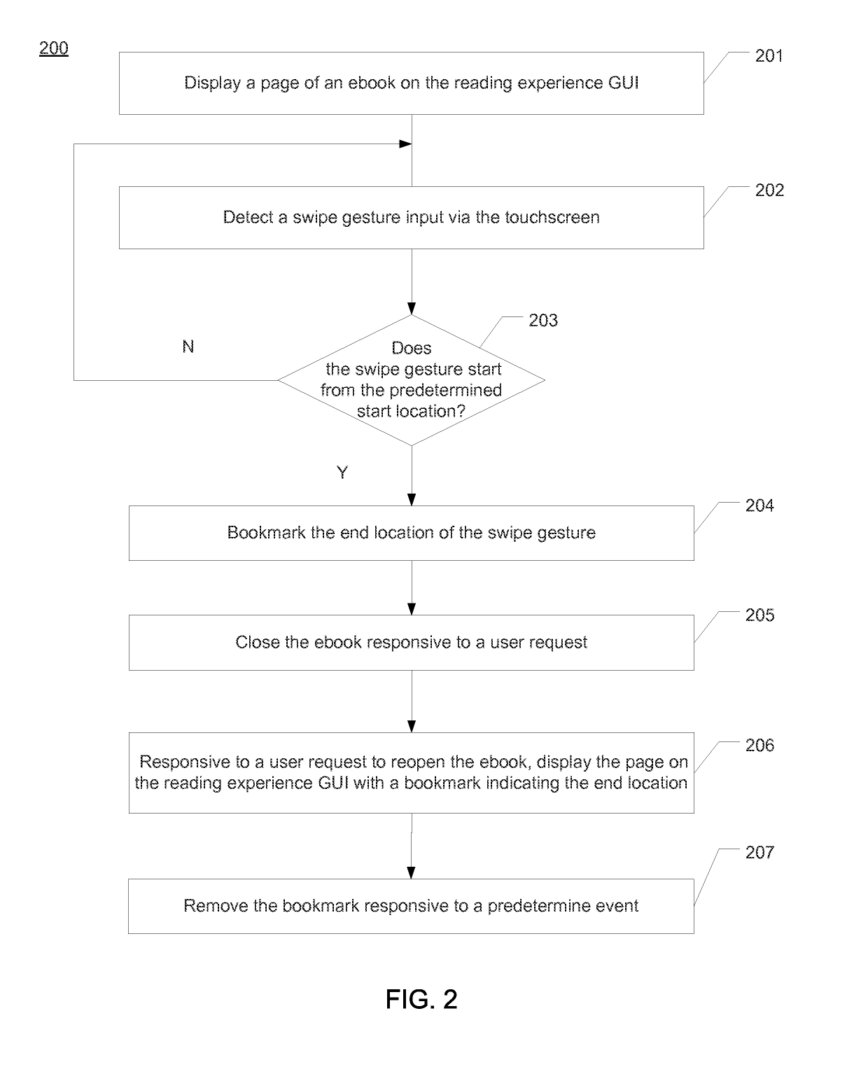

FIG. 2 is a flow chart depicting an exemplary computer implemented method 200 of bookmarking a select location within a page of an electronic book responsive to a user swipe gesture input in accordance with an embodiment of the present disclosure. Method 200 may be implemented as a software program on an electronic reading device as an integral part of a book reading experience program, or a separate application program.

At 201, a reading experience GUI is rendered on an electronic reading device to display the content of a select electronic book (ebook). The electronic reading device is equipped with a touch sensitive display panel, or a touchscreen. For instance, the reading experience GUI includes a content display area configured to display a single page of the ebook. At 202, a user swipe gesture input is detected by the touchscreen.

If it is determined that the swipe gesture starts from a predetermined location of the GUI at 203, the gesture is processed and interpreted as a user request for bookmarking. Then the end location of the swipe gesture is bookmarked, or recorded as the selected location for bookmarking. The end location represents the last line that the reader read in the content reading session. At the same time, a visual object representing the bookmark location is displayed on the GUI. As will be described in greater detail, the visual object may be in the form of a line pointing to the selected location. Thus, the visual object can facilitate a user to identify the selected location later in the current or a subsequent reading session.

On the other hand, if the detected swipe gesture starts from a location other than the predetermined location, the gesture is not to be processed as a user request for bookmarking.

At 205, the ebook or the reading experience GUI is closed in response to a user request, denoting the end of the current reading session.

At 206, responsive to a user request to re-open the ebook in a new reading session, the ebook is accessed and presented in the reading experience GUI again. The last page that is viewed in the previous reading session may be displayed first in the new reading session. Importantly, the bookmark visual object is also displayed to indicate the select location of the page to commence reading. Therefore, in the new reading session, the user can rely on the bookmark visual aid to quickly locate the last line he or she finished reading and continue to read from there.

At 207, the bookmark visual indicia is removed from the GUI responsive to a predetermined event which may be a detection of a tap gesture applied on the visual object, receiving a user instruction to display another page on the GUI, or after a predetermine time. In effect, the bookmark indicia is only visible to a user to the extent it is useful to inform the user of the last-read line.

It will be appreciated that bookmarking a select location within a page according to the present disclosure can be used to serve any suitable user purposes. Ter method according to the present disclosure can be used to bookmark a select portion of an electronic magazine, newspaper, or a text file, which is possibly accompanied with images, videos or other media formats. The select location may direct to any part or type of content contained in an electronic document, such as a term, a line, a paragraph, a graphic object, a symbol, space, an icon representing a video clip or audio clip, etc.

The reading experience GUI may include an icon representing the predetermined position for a user to start a gesture for bookmarking a select location within a page. The icon may be static, or alternatively only appear when a user places a finger proximate to the predetermined position.

It will be appreciated that the predetermined position can be represented by a visual object of any suitable shape, form or size. In some embodiments, the predetermined location may correspond to a circular region having an assigned area. The circular region may be located any place within the reading experience GUI. A detected swipe gesture starting from any point within the circular region can then be recognized as a bookmarking request as described with reference to FIG. 2. In some other embodiments, the predetermined location may correspond to a rectangular or linear region, e.g., along the left margin surrounding the content display area. A swipe gesture starting at any point along the linear region can be recognized as a bookmark request.

In some embodiments, any swipe gesture staring from the predetermined position can be detected and processed as a bookmark request, regardless of the motion orientation (or the path between the start and end positions) thereof.

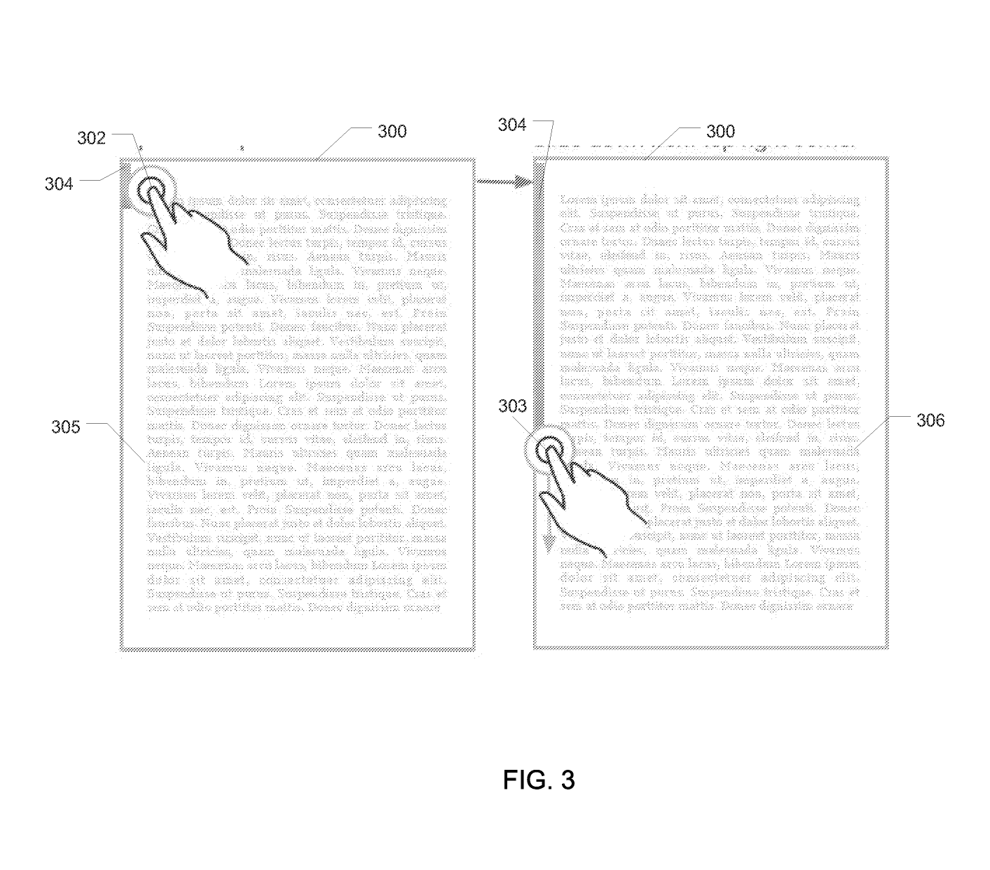

FIG. 3 illustrates an exemplary GUI 300 configured to receive a user swipe gesture via a touchscreen display to bookmark a text line 306 in an electronic document in accordance with an embodiment of the present disclosure. As illustrated, while the GUI 300 displays a page 305 of the document, the user 301 swipes down from the predetermined location 302 on the GUI 300 along the left margin up to an intended end position 303. A bar object 304 is rendered on the GUI 300 with one end fixed at the predetermined location 302 and the other end following the path of the swipe gesture in real-time until the user releases the finger from the touchscreen display at the end position 303. The end position 303 is on the same horizontal level with the text line 306 which is intended to be bookmarked.

After the swipe gesture completes and the end location 303 is determined, the end location 303 is stored as a bookmark of the electronic document. The bar object 304 remains associated with the page and visible on the GUI 300 until the bookmark is removed. In some embodiments, the visual object 304 remains visible until the GUI 300 receives a user instruction to delete or remove it. In some embodiments, the visual object 304 remains visible until an associated page is displayed on the GUI 300 for a certain time interval in a subsequent reading session.

According to the present disclosure, a bookmark for a select portion within a page can be generated independent of the path of the gesture input. A gesture may follow a curved path, a spiral path, a zigzag path, a straight path of any angle, etc. However, in some other embodiments, swipe gestures are limited to one or more specific type of paths, e.g., a vertical line down from a predetermined position located at the upper corner, or a horizontal line from a predetermined position located on the left margin.

It will be appreciated that the visual object indicia representing the bookmark may be configured in any suitable form that is well known in the art. In some embodiments, the visual object reflects the path of the swipe gesture, such as a straight down line, or a wavy line. However, in some other embodiments, the visual object has a fixed form that is independent of the path of the gesture, e.g, an arrowed line pointing to the end position.

Although embodiments of the present disclosure are primarily described with reference to user swipe gestures, it will be appreciated that one or more other suitable gestures, e.g., a drag, a slide, a pinch gesture may also be detected and processed as a bookmark request according to the present disclosure. For example, a pinch gesture with one finger starting from the predetermined location and the other finger starting from the selected location can be identified as a bookmark request.

For purposes of practicing the present disclosure, a reading experience GUI may include a number of additional widgets, icons, and graphical objects configured to perform respective functions that are well known in the art.

The method of bookmarking a select location of a document through a GUI according to the present disclosure can be implemented on any suitable electronic reading device, including a desktop, portable computers, personal digital assistance (PDAs), mobile, phone, e-readers, touchpads, and etc.

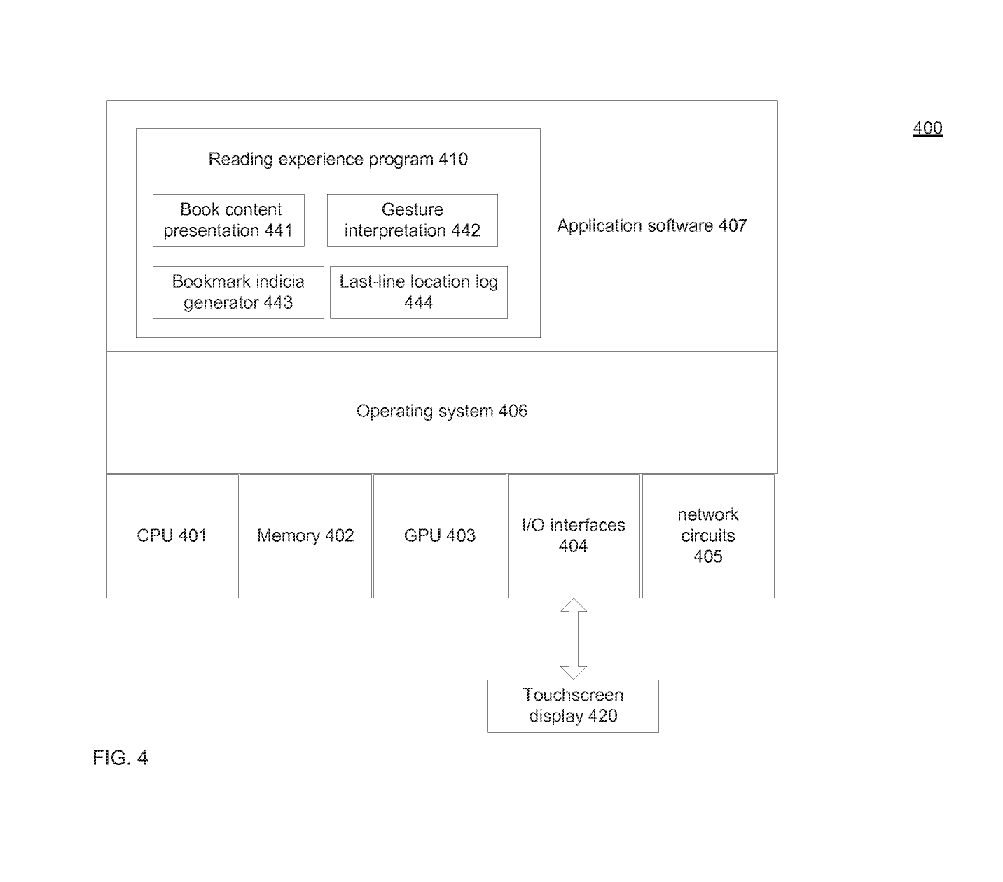

FIG. 4 is a block diagram illustrating an exemplary computing system 400 including a reading experience program 410 capable of bookmarking a select location within a select page of a document responsive to a gesture input in accordance with an embodiment of the present disclosure. The computing system 400 comprises a central processing unit (CPU) 401, system memory 402, a graphics processing unit (GPU) 403, I/O interfaces 404, network circuits 405, an operating system 406 and application software 407 including the reading experience program 410 stored in the memory 402. Electronic documents to be presented by the reading experience program can be stored in a secondary storage device associated with the computing system 700.

In some other embodiments, the computing system 400 may also be coupled to a server (not shown) through a communication channel. Electronic documents to be presented by the reading experience program can be stored in and accessed from the server. The server may be hosted by an on-line book store, a library, a publisher, or other electronic document content provider, etc.

The computing system 700 is equipped with a touchscreen display 720 coupled to the processors 701 and 703 through an I/O interface 704. For purposes of implementing this disclosure, any well known touch screen technology can be used to receive a user input for bookmarking. The technology of the present disclosure is not limited by any particular type of touch-sensing or proximity-sensing mechanism employed by the touchscreen. The touchscreen 420 can be a resistive touchscreen, a capacitive touchscreen, an infrared touchscreen, or a touchscreen based on surface acoustic wave technology, etc. A user gesture input through a touchscreen can be detected, processed, and interpreted by any suitable mechanism that is well known it the art.

Further, the input mechanism for purposes of this disclosure can be a finger tip, a passive stylus, an active stylus, or any other type of suitable means that are compatible with the sensing mechanism and the touchscreen installed in the computing device. For example, swipe gestures can be performed using any cursor directing device, such as a mouse, and a joystick, a keyboard, and a stylus.

In the illustrated example, the reading experience program 410 comprises a book content presentation module 441, a gesture interpretation module 442, a bookmark indicia generation module 443 and an end location log module 444.

When incorporating configuration input and personalized input and executed by the CPU 401, the reading experience program 410 can present book content in a book reading GUI by performing the book content presentation module 441. Upon a swipe gesture input being received through the touchscreen 420, an indication including data representing the start location and the end location of the swipe gesture is received and interpreted by the gesture interpretation module 442. Based on the staring location of the gesture input, the gesture interpretation module 442 can recognize the gesture as a bookmark request as described with reference to FIGS. 2 and 3.

The bookmark indicia generation module 443 can be configured to render on-screen indicia to indicate the predetermined location and a bookmark visual object responsive to a recognized bookmark gesture. The end location log 444 can be used to store the end location of a bookmark gesture and provide it to the bookmark indicia generation module 443 to generate the bookmark visual object.

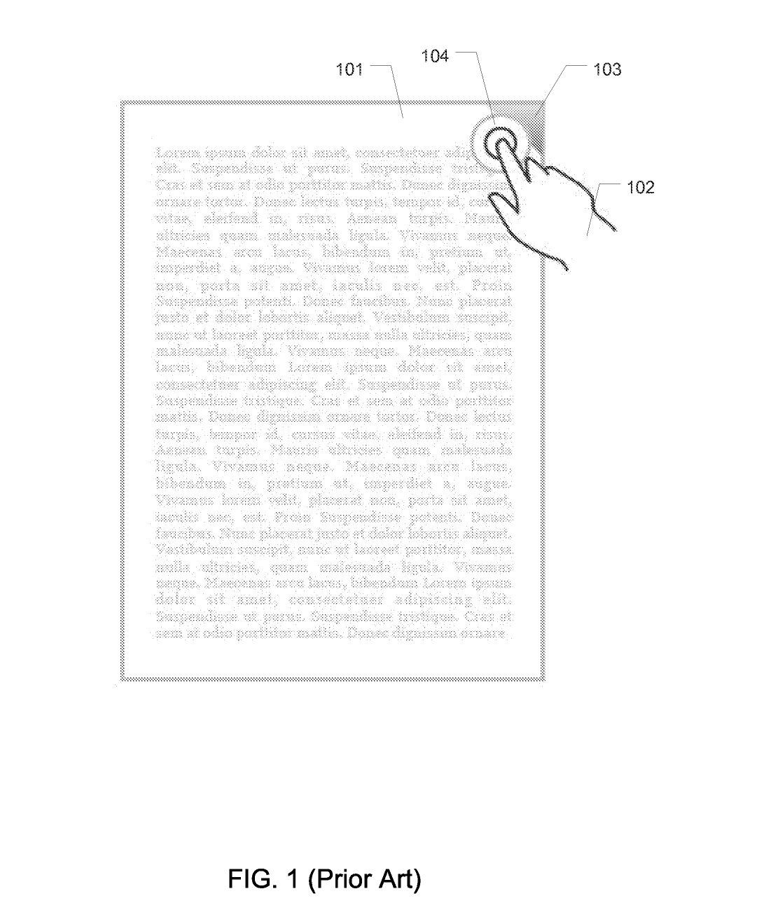

The reading experience program 410 may perform various other functions as discussed in details with reference to FIG. 1-FIG. 3. As will be appreciated by those with ordinary skill in the art, the reading experience program 410 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of bookmarking a location in an electronic book, said computer implemented method comprising:
accessing content of said electronic book;
rendering an on-screen graphical user interface (GUI) on a touch sensitive display device in a first view session to display a portion of said electronic book;
detecting an indication of a slide gesture via said touch sensitive display device, wherein said indication comprises data representing a start location of said slide gesture and data representing an end location of said slide gesture, wherein said start location corresponds to a predetermined location with reference to said on-screen GUI;
recording said end location with reference to said portion as a bookmark for said electronic book; and
rendering an on-screen indicia on said on-screen GUI, said on-screen indicia indicating said end location with reference to said portion.

2. The computer implemented method of claim 1, wherein said on-screen GUI comprises an on-screen graphical object indicating said predetermined location, and wherein said portion is a page.

3. The computer implemented method of claim 2, wherein said on-screen graphical object remains invisible until a user interaction with said touch sensitive display device is detected proximate to said predetermined location.

4. The computer implemented method of claim 1, wherein said on-screen indicia comprises a bar object connecting said predetermined location and said end location.

5. The computer implemented method of claim 1, wherein said rendering said on-screen indicia further comprises displaying a part of said page that precedes said end location in a text display format different from a part of said page following said end location.

6. The computer implemented method of claim 1, wherein said recording is performed independent of a motion orientation of said slide gesture.

7. The computer implemented method of claim 1 further comprising:
ending said first view session of said electronic book in response to a first user request via said on-screen GUI, wherein said ending is performed subsequent to said recording;
rendering said on-screen GUI on said touch sensitive display device to display said portion in response to a second user request to start a second view session of said electronic book, wherein said second user request is received through said touch sensitive display device subsequent to said ending; and
displaying said on-screen indicia on said on-screen GUI in said second view session.

8. The computer implemented method of claim 7 further comprising removing said on-screen indicia from said on-screen GUI after a predetermined time in said second view session.

9. A non-transitory computer-readable storage medium embodying instructions that, when executed by a processing device, cause the processing device to perform a method of labeling a location in an electronic document, said method comprising:
rendering a graphical user interface (GUI) for reading on a touchscreen display;
displaying a portion of said electronic document on said GUI in a first reading session of said electronic document;
receiving an indication of a swipe gesture via said touchscreen display; wherein said indication comprises data representing a start position of said swipe gesture with reference to said GUI, and data representing an end position of said swipe gesture with reference to said portion of said electronic document, wherein said start position coincides with a predetermined position on said GUI;
storing said end position with reference to said electronic document as a bookmark; and
closing said first reading session in response to a user request;
responsive to a user request to start a second reading session subsequent to said closing, displaying said portion of said electronic document on said GUI; and
rendering an on-screen indicia on said GUI in said second reading session, wherein said on-screen indicia is indicative of said end position.

10. The non-transitory computer-readable storage medium of claim 9, wherein said method further comprises removing said on-screen indicia in response to a user interaction with said GUI, wherein said user interaction comprises a tap gesture.

11. The non-transitory computer-readable storage medium of claim 9, wherein said GUI comprises a graphical object indicating said predetermined position.

12. The non-transitory computer-readable storage medium of claim 9, wherein said swipe gesture comprises a drag motion from said predetermined position to said end position.

13. The non-transitory computer-readable storage medium of claim 9, wherein said end position corresponds to a line of said electronic document.

14. The non-transitory computer-readable storage medium of claim 9, wherein said electronic document is selected from a group consisting of an electronic book, an electronic magazine, a text file, and an electronic newspaper.

15. The non-transitory computer-readable storage medium of claim 9, wherein said portion of document is divided into a viewed portion and an unviewed portion by said end location, wherein said method further comprises displaying said viewed portion in a different format from said unviewed portion in said second reading session.

16. A system comprising:
a touch sensitive display device operable to detect user gestures;
a processor coupled to said touch sensitive display device;
memory coupled to said processor and comprising instructions that, when executed by said processor, cause the system to perform a method of bookmarking a location in an electronic book, said method comprising:
accessing content of said electronic book;
rendering an on-screen graphical user interface (GUI) on said touch sensitive display device in a first view session to display a page of said electronic book;
receiving an indication of a slide gesture via said touch sensitive display device, wherein said indication comprises data representing a start location of said slide gesture and data representing an end location of said slide gesture, wherein said start location corresponds to a predetermined location with reference to said on-screen GUI;
recording said end location with reference to said page as a bookmark; and
rendering an on-screen indicia on said on-screen GUI, said on-screen indicia indicating said end location with reference to said page.

17. The system of claim 16, wherein said on-screen GUI comprises an on-screen graphical object indicating said predetermined location, and wherein said on-screen graphical object remains invisible until a user interaction with said touch sensitive display device is detected proximate to said predetermined location.

18. The system of claim 16, wherein said rendering said on-screen indicia comprises: rendering a line object directing to said end location; and displaying a portion of said page that precedes said end location in a format different from a portion of said page that follows said end location.

19. The system of claim 16, wherein said method further comprises:
subsequent to said recording, ending said first view session of said electronic book in response to a first user request via said on-screen GUI;
rendering said on-screen GUI on said touch sensitive display device to display said page in response to a second user request to start a second view session of said electronic book, wherein said second user request is received through said touch sensitive display device subsequent to said ending; and
displaying said on-screen indicia on said on-screen GUI in said second view session.

20. The system of claim 19, wherein said method further comprises removing said on-screen indicia from said on-screen GUI after a predetermined time in said second view session.
